(19) United States
(12) Patent Application Publication
(10) Pub. No.: US 2012/0048464 A1
(43) Pub. Date: Mar. 1, 2012

(54) Ultraviolet Activated Seal For Photopolymer Plate Mounting

(75) Inventors: Patrick Roger Simmons, Florence, KY (US); James Scott Orcena, Erlanger, KY (US); Jerome J. Lorenz, Westerville, OH (US)

(73) Assignee: International Paper Company, Memphis, TN (US)

(21) Appl. No.: 12/868,232

(22) Filed: Aug. 25, 2010

(51) Int. Cl. B29C 65/14

(52) U.S. Cl. 156/275.3

(57) ABSTRACT

A method of sealing a printing plate, such as a photopolymer printing plate, to a carrier sheet. A UV-curable adhesive resin is applied to the parameter of the printing plate once positioned on the backing carrier sheet and the resin is cured using ultraviolet radiation. The curing time of less than ten minutes is significantly shorter than that of conventionally used sealants and is more resistant to environmental factors caused by use of the plate and backing during printing.

### TECHNICAL FIELD

This invention relates generally to plates for printing and the like, and more particularly to materials and methods to better adhere printing plates to backing materials.

### BACKGROUND

Virtually all consumer products are sold in packages, such as cardboard cartons, boxes, and other types of containers. A package has two very distinguishing features: a structural design and a graphical design. The structural design of a package is defined by the package's structural features, such as the dimensions, geometric shape, and material of the package. The graphical design of a package is defined by the colors, artwork, and other images applied thereto. The graphical design preferably identifies the packaged product in a manner which is aesthetically appealing to potential consumers.

A package is typically formed from a sheet of corrugated board, carton board, or other work material upon which a graphical design is applied. The graphical design may be applied by many known processes. For example, a sheet having a design may be laminated to the package, or the package itself may be printed.

One common printing method is that of flexography. A flexographic print is made by creating a positive mirrored master of the required image as a 3D relief in a rubber or polymer material. Flexographic plates can be created with analog and digital platemaking processes. The image areas are raised above the non-image areas on the rubber or polymer plate. The ink is transferred from the ink roll which is partially immersed in the ink tank. Then it transfers to the anilox roll (or meter roll) whose texture holds a specific amount of ink since it's covered with thousands of small wells or cells that enable it to meter ink to the printing plate in a uniform thickness evenly and quickly (the number of cells per linear inch can vary according to the type of print job and the quality required). To avoid getting a final product with a smudgy or lumpy look, it must be ensured that the amount of ink on the printing plate is not excessive. This is achieved by using a scraper, called a doctor blade. The doctor blade removes excess ink from the anilox roller before inking the printing plate. The substrate is finally sandwiched between the plate and the impression cylinder to transfer the image.

In corrugated flexographic printing, photopolymer plates are pre-mounted to a sheet of PVC/Mylar, plastic or metal, of various size, commonly referred to as a piece of backing or a carrier. The pre-mounted plate is then attached to the printing press, saving valuable press set up time.

During the pre-mount process, a layer of plate sealer is applied to the perimeter of each individual printing plate. The sealer's purpose is to provide an extra level of adhesion of the plate to prevent separation or lifting of the polymer plate from the plastic sheet during standard printing operations. A secondary purpose is to prevent water, cleaning solution, water based ink or solvent from migrating underneath the polymer plate, during the printing or cleaning processes. Water and cleaning solutions can compromise the adhesive used to attach the plate to the carrier sheet. This can result in separation of the plate from the backing or carrier sheet. The currently known products available, display variation in durability, application method, curing times, longevity, tamper resistance and the likelihood of failing in the field. These issues have continued to aggravate the corrugated photopolymer plate makers and the corrugated printers who utilize these types of products.

Plate sealing problems have conventionally included:

Difficulty shipping highly flammable sealers to from sealer manufacturer to plate making locations.
Current sealers have multiple hazards associated with them such as low flash points and flammability ratings as well as health hazards.
   Sealers have high volatile organic chemicals (VOCs).
   Plate making employees working with sealers that exhibited strong odors and caused nausea.

Sealers that take excessive time to cure or set by evaporation, causing the plate maker to miss ship times or send plates with only partially cured sealer.

Sealers that attack the backing material, causing it to deform and become rippled.

Sealers that fail and cause the plate to lift from the carrier. Current commercially available sealers are easily removable by hand, with a fingernail, rubbing with a fingertip or application of a liquid solvent based chemical. When this occurs, unwanted print from the lifted area of the plate is printed, causing waste.

Sealers that fail in the field, even before the plates are used the first time, causing the corrugated printers to apply additional sealer to prevent the plates from coming loose.

Therefore, there exists a need for a plate sealer, and methods of applying plate sealers, that avoids the problems of prior art sealers.

### BEST MODE FOR CARRYING OUT THE INVENTION

Apart from the use of a UV cure sealer, as described and claimed herein, it is anticipated that flexographic plates are attached to carrier/backing as is known in the art. Flexographic plates, such as photopolymer plates by way of example, and carrier materials are also utilized as may be known in the art. The term “UV cure adhesive sealer” shall refer to adhesives that are cured by the application of light or other radiation of the ultraviolet spectrum, such spectrum as generally defined as a wavelength between 10 to 400 nanometers (nm) and having energies between 3 to 124 electron volts (eV). It should be noted that particular UV cure adhesive sealers may have confined and/or optimum wavelengths and/or energies within the general UV spectrum under which they function as intended such as, by way of example, operation under the UV-A spectrum (400-315 nm, 3.10-394 eV). One such UV cure adhesive sealer, UVA 4110, is supplied by Star Technologies (Waterloo, Ind.).

One or more photopolymer plates are pre-positioned on top of the plastic (typically) carrier, as required to obtain the final printing sheet that will be placed on the printing rolls. To practice the inventive method one would first apply the UV cure adhesive sealer around the perimeter of the photopolymer plate of interest from the manufacturer's supplied syringe or a bottle or a standard bottle having flattened tip applicator Alternatively, one can apply the adhesive sealer to the bottom of the photopolymer plate and then place the plate on to of the carrier. This has the disadvantage, however, of possible inaccuracy of placement once the adhesive sealer is applied. In a second alternative, one can apply the UV cure adhesive to the carrier plate, although this is also not preferred as it is difficult to achieve a seal without gaps at the edge of the photopolymer plate.

After achieving the desired coverage area to the polymer plate and plastic carrier backing (partially on the plate edge and surface as well as approximately onto the plastic backing, preferably ⅛″), the Carrier sheet (finished, mounted product) is be transported to and placed on a UV light exposure unit. The exposure unit is then turned on and set to expose the product to UV light, preferably in our development of the inventive method, UVA light @350-400 nm. We have found that exposure to the UV source is between 5 to 10 minutes, preferably between 8 to 10 minutes and most preferably 10 minutes. No significant benefits were shown after 10 minutes of exposure. There is an efficiency regarding time of process. Current (non-UV) commercial sealers require from 2-24 hours to cure completely and drying/curing time is affected by the amount and thickness of sealer applied. Having a consistent and shorter cure time allows for shorter predictable through time. This is particularly important when a printing sheet is required on expedited basis and must be shipped or used. Because of long conventional sealer cure times,

Commercial sealers have a low viscosity and are more of a liquid like product. The UV cure adhesive sealer has a higher viscosity and is similar to the consistency of toothpaste. The benefit is realized during application by the product not migrating to undesired areas, potential damage to the plate material if allowed to cure on the surface and waste of the sealer by partially uncontrollable spilling of the sealer. There is minimal shrinkage upon curing of the UV cure adhesive.

The UV cure adhesive sealer was not removable by hand after cure, unlike many conventional sealers used in photopolymer plate mounting applications. Tools such as a palette knife must be used with excessive force in order to break the UV-curable adhesive seal. This should lead to durability in the field. As such, it is believed that lifting of printing plates from the carrier sheet will be nearly eliminated with the use of UV cure adhesive sealer.

The UV cure adhesive sealer did not breakdown when exposed to solvent based chemicals. Solvent was poured onto and rubbed into the cured sealer for 10 minutes without visible breakdown or degradation of the bond to the plastic backing or photopolymer plate material as well as the sealer itself. Again, this will translate to additional durability in the field.

It should be understood that various changes and modifications may be made in the invention without departing from the spirit and intent of the invention as defined by the appended claims. While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for mounting a printing plate to a backing sheet, the method comprising:
a. positioning the printing plate having an outside perimeter on the backing sheet;
b. applying a curable sealer at an interface between the outside parameter of the backing sheet, said curable sealer being curable by the application of ultraviolet radiation;
c. exposing the curable sealer to ultraviolet radiation for a period of time, curing the sealer
whereby, the printing plate is mounted to the backing sheet by why of the cured sealer.

2. The mounting method of claim 1 wherein, the curable sealer is exposed to ultraviolet radiation for a time between approximately 5 minutes and approximately 10 minutes.

3. The mounting method of claim 1 wherein the curable sealer is exposed to ultraviolet radiation for a time between approximately 8 minutes and approximately 10 minutes.

4. The mounting method of claim 1 wherein the curable sealer is cured by ultraviolet-A (UVA) radiation.

5. The mounting method of claim 4, wherein the curable sealer is cured by radiation having a wavelength approximately between 400 and 315 nanometers (nm).

6. The mounting method of claim 1 wherein the printing plate is comprised substantially of a photopolymer.
